(19) United States
(12) Patent Application Publication
(10) Pub. No.: US 2005/0274694 A1
(43) Pub. Date: Dec. 15, 2005

(54) Manufacturing method of semiconductor device

(76) Inventors: Michimasa Funabashi, Hachioji (JP); Shigeru Omata, Otsuki (JP); Nobuaki Toma, Iwaki (JP); Masatoshi Fukushima, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/148,403

(22) Filed: Jun. 9, 2005

(30) Foreign Application Priority Data
Jun. 15, 2004 (JP) 2004-176487

(51) Int. Cl. B44C 1/22; C23G 1/00

(52) U.S. Cl. 216/75; 134/2

(57) ABSTRACT

A semiconductor manufacturing apparatus capable of removing metal derived from an electrode from ozone generated by the silent discharge is provided. The ozone generated by the silent discharge between electrodes in the ozone generating unit is permeated through a molecule permeable film based on pressure difference between the back and the front of the molecule permeable film constituting a filter. The permeated ozone is supplied together with separately-generated water vapor to a resist surface on a semiconductor wafer to remove the resist. In the resist removal described above, the high-concentration metal contamination due to the metal derived from an electrode can be prevented.

### CROSS-REFERENCE TO RELATED APPLICATION

The present application claims priority from Japanese Patent Application JP 2004-176487 filed on Jun. 15, 2004, the content of which is hereby incorporated by reference into this application.

### TECHNICAL FIELD OF THE INVENTION

The present invention relates to a technology for removing a minute amount of metal contained in gas. More particularly, the present invention relates to a technology effectively applied to the removal of metal which is contained in gas such as ozone used in the field of semiconductor manufacturing and a minute amount of metal contained in gas causes the semiconductor wafer contamination.

### BACKGROUND OF THE INVENTION

The technology described below has been examined during the development of the present invention by the inventors thereof, and its outline will be shown as follows.

In the manufacture of a semiconductor device, ozone (O₃) is used because of its high oxidizing power. Ozone is used in a gaseous state in some cases and is also used as ozone water obtained by dissolving it into water.

In the case where ozone in a gaseous state is used, for example, ozone is used for the resist removal after the etching process in a series of the photolithography processes. In the resist removal, the process using oxygen plasma has been used so far. However, the use of the oxygen plasma causes various failures such as the reduction of the tolerance of a gate oxide film of a semiconductor wafer.

In such a circumstance, as a removal method of resist which does not cause any damage, the method in which ozone is sprayed onto a resist surface to oxidize and decompose the resist has been suggested. Further, the method in which ozone is sprayed in the presence of moisture in order to improve the decomposition efficiency has been also suggested.

For example, Japanese Patent Application Laid-Open No. 2001-176833 has suggested the technology as follows. That is, when a series of processes in the photolithography process from the resist removal process to the cleaning and dry process are performed in the single apparatus, a thin liquid film of purified water is formed on a resist surface by using water vapor supplied from water vapor supply means, and then, ozone supplied from ozone supply means is dissolved into the liquid film. By doing so, the resist is decomposed into carboxylic acid, carbon dioxide, water, and others.

Also, Japanese Patent Application Laid-Open No. 2002-57136 has disclosed the configuration for cleaning a substrate using ozone water. In this configuration, ozone generated from an ozone generator, and water into which the ozone is to be dissolved by a nonporous ozone gas permeable polymer film which allows only gas to permeate and blocks the permeation of fluid, and ozone and water are isolated from each other by the film. Therefore, different from the case where the ozone is brought into direct contact with water, the ozone is permeated through the nonporous ozone gas permeable polymer film in a pressurized state, and as a result, the clean and high-concentration ozone water in which metal particles or the like resulting from the ozone generation are not dissolved can be produced.

### SUMMARY OF THE INVENTION

The inventors of the present invention have found that the high-concentration metal contamination occurs in a semiconductor wafer when a resist is removed by supplying the gaseous ozone together with the water vapor to the resist surface in the removal process of a resist formed on a semiconductor wafer in the photolithography process in the manufacture of a semiconductor device. The critical metal contamination leading to the product failure as described above proves to be caused by metal derived from an electrode. The above-described metal contamination is caused by the metal derived from an electrode formed when generating the ozone by the silent discharge between electrodes.

However, even in the case where the similar ozone generated by the silent discharge is used, the problem of the high-concentration metal contamination does not occur in the resist removal method in which only the gaseous ozone is sprayed. Also, the problem of the high-concentration metal contamination does not occur in the case where the resist is removed by supplying the already-produced ozone water to the resist surface.

Therefore, the inventors of the present invention have considered that the high-concentration metal contamination is caused when the ozone contaminated with metal derived from an electrode is brought into contact with the water vapor supplied together with the ozone to the resist surface and the metal contained in the ozone is dissolved into the water vapor. Since the amount of water vapor is small, the dissolution of the metal into the water vapor results in the extremely high metal concentration. When the ozone in a gaseous state is used, the metal concentration in the ozone is low because it is diluted by the large amount of gas. Also, in the case of using the ozone water produced by dissolving ozone into water, since the ozone water is produced by dissolving ozone into a large amount of water, the metal concentration in the ozone is probably low.

However, in the case where the water vapor is supplied together with the ozone to the resist surface as described above, different from the case of using the ozone water and the like, the amount of water vapor to which the metal is dissolved is quite small and therefore the metal concentration is extremely increased.

Therefore, in the process in which the water vapor is supplied together with the ozone to the resist surface, the method adopting the ozone generation means using the electrolysis of water is available as one of the means for preventing the high-concentration metal contamination described above. However, since it is difficult to acquire the sufficient ozone concentration in this method and the cost thereof is high in comparison to the ozone generation method using the silent discharge between electrodes, this method is difficult to use in practice.

Consequently, it is necessarily desired to use the ozone generation method by the silent discharge. The inventors of the present invention have considered that it is necessary to solve the problem of the metal contamination when using the ozone generated by the silent discharge in the above-described configuration in which the water vapor is supplied together with the ozone to the resist surface. Since this configuration is different from that of the method in which ozone water is produced by dissolving ozone into a large amount of water, the configuration of dissolution module in which ozone is isolated from water by a nonporous ozone gas permeable polymer film like Japanese Patent Application Laid-Open No. 2002-57136 cannot be used.

The inventors of the present invention have considered that it is necessary to develop a filtering technology for removing the contamination metal from supplied ozone before the ozone is brought into contact with the water vapor in the process in which the resist is removed by bringing water vapor into contact with ozone on the resist surface.

An object of the present invention is to remove the metal contamination derived from an electrode from the ozone generated by the silent discharge.

Another object of the present invention is to remove the metal contamination in gas such as process gas.

The above and other objects and novel characteristics of the present invention will be apparent from the description and the accompanying drawings of this specification.

The typical ones of the inventions disclosed in this application will be briefly described as follows.

More specifically, the metal in ozone derived from an electrode is removed by allowing the ozone to permeate a molecule permeable film based on the pressure difference.

Further, the following apparatus may be also available.

1. A semiconductor manufacturing apparatus having a gas-processing function for processing a semiconductor wafer by gas comprises metal removal means for removing metal contained in the gas by a molecule permeable film which allows the gas to permeate but does not allow the metal to permeate before processing the semiconductor wafer by the gas.

2. In the semiconductor manufacturing apparatus according to item 1, the gas-processing function is a resist removal processing function to remove a resist provided on the semiconductor wafer by using water vapor and ozone as the gas.

3. In the semiconductor manufacturing apparatus according to item 1, the gas-processing function is a film forming processing function to form a film on the semiconductor wafer by using the gas as material gas.

Moreover, the following method may be also available.

4. A method of removing metal in gas comprises the steps of: permeating gas contaminated with metal, through a molecule permeable film which allows the gas to be permeated but does not allow metal to be permeated by difference in pressure between a gas inflow side and a gas outflow side of the molecule permeable film; and removing the metal from the gas.

The effect obtained by the representative one of the inventions disclosed in this application will be briefly described as follows.

By using the molecule permeable film, the metal in ozone due to the generation of the ozone can be removed, and the problem of the high-concentration metal contamination can be solved in the process in which the resist is removed by bringing the ozone and the water vapor into contact at a point of use.

### BRIEF DESCRIPTION OF THE DRAWINGS

FIG. 1 is an explanatory diagram schematically showing an example of the configuration of the semiconductor manufacturing apparatus according to an embodiment of the present invention.

FIG. 2 is a flowchart showing the process flow of the manufacturing method of a semiconductor device according to an embodiment of the present invention.

FIG. 3 is an explanatory diagram schematically showing an example of the case where the semiconductor manufacturing apparatus according to the present invention is used as the CVD apparatus.

### DESCRIPTION OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

The present invention relates to a technology for removing metal contained in gas such as ozone (hereinafter, it may be referred to as gas). For example, the present invention can be effectively applied to the removal of metal derived from an electrode, that the metal is inevitably contained in ozone generated by the silent discharge and causes the contamination, from ozone.

Therefore, in the process using ozone generated by the silent discharge, for example, in the process in which a resist is removed by supplying ozone together with water vapor to the resist surface, the high-concentration metal contamination derived from an electrode does not occur after the resist removal process.

In addition, this removal of metal in ozone can be also applied to the gas other than ozone. For example, it can be effectively applied to the removal of contamination metal in material gas supplied to the CVD (Chemical Vapor Deposition) apparatus and the like. Also, it can be effectively applied to the means of the resist removal process in which ozone generated by the silent discharge is reacted in a gaseous state without using it together with water vapor though the problem of the metal contamination has not become obvious therein at present.

### First Embodiment

The configuration for removing metal derived from an electrode from ozone generated by the silent discharge according to the present invention will be described in this embodiment with using the resist removal as an example.

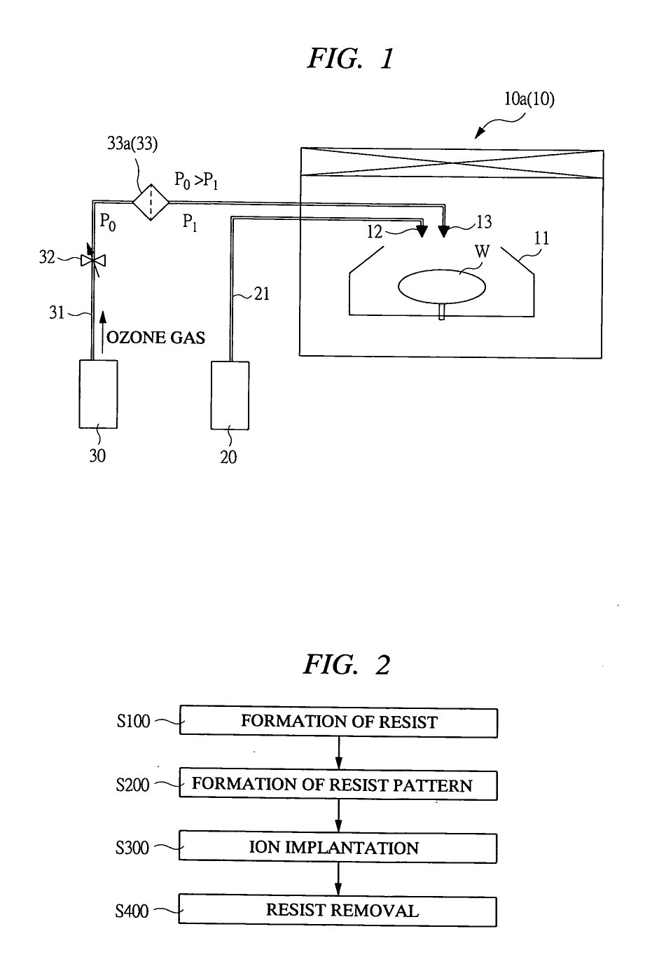

FIG. 1 is an explanatory diagram of the entire configuration schematically showing the case where the semiconductor manufacturing apparatus according to the present invention is used as the resist removal apparatus. FIG. 2 is a flowchart showing the process flow of the manufacturing method of a semiconductor device according to an embodiment of the present invention.

The semiconductor manufacturing apparatus 10 described in this embodiment is used as the resist removal apparatus 10a having a gas-processing function to remove the resist by using ozone as shown in FIG. 1. The resist removal apparatus 10a is comprised of a chamber 11 and holds a semiconductor wafer W on a wafer holding section.

A plurality of nozzles 12 and 13 are provided on the upper side of an opening of the chamber 11. The nozzle 12 is connected to a water vapor generating unit 20 through a pipe 21, and water vapor is supplied to the semiconductor wafer W held in the chamber 11.

Meanwhile, the nozzle 13 is connected to an ozone generating unit 30 through a pipe 31, and ozone is supplied to the semiconductor wafer W held in the chamber 11 together with the water vapor. In the ozone generating unit 30, the ozone is generated by the silent discharge between electrodes.

As shown in FIG. 1, a control valve 32 and a filter 33 are provided on the pipe 31 which connects the ozone generating unit 30 and the nozzle 13. The filter 33 is composed of a molecule permeable film 33a which allows ozone to permeate but does not allow metal contained in the ozone to permeate.

The molecule permeable film 33a is a permeable film made of resin such as fluorocarbon resin, which allows gas such as ozone to permeate but does not allow metal particles slightly contained in the ozone to permeate. In general, in the filter for removing a foreign matter such as floating dusts in gas, pores of about 0.1 μm which does not allow foreign matters to permeate but allows gas to permeate are artificially formed in a resin film or the like. However, the molecule permeable film used in the present invention is not provided with such artificial pores. The molecule permeable film is commercially available and is sometimes called a poreless molecule permeable film or the like.

The filter 33 composed of such a molecule permeable film 33a functions as metal removing means for removing the metal in gas such as ozone.

With using the resist removal apparatus 10a having the above-described molecule permeable film as the metal removing means, the manufacturing method of a semiconductor device including the gas-processing step using the ozone generated by the silent discharge between electrodes will be described.

In the description below, the case where the resist used in the ion implantation process is removed by using the semiconductor manufacturing apparatus 10 used as the resist removal apparatus 10a with the above-described configuration will be used as an example.

In the previous process, a silicon oxide film with a thickness capable of burying a shallow trench for device isolation formed in advance is deposited on a semiconductor wafer, and then, the surface of the silicon oxide film is flattened by the chemical mechanical polishing. In this state, a resist film (photoresist film) is formed on the silicon oxide film in the step S100 as shown in FIG. 2. Thereafter, in the step S200, the resist film is exposed to light with using a mask having a pattern for the ion implantation and is developed to form the resist pattern for the ion implantation.

In the step S300, phosphorus (P) ions are implanted from the ion implantation equipment with using the above-described resist pattern as a mask to form an N well. Thereafter, in the step S400, the resist film used as a mask is removed. The above-described resist removal apparatus 10a according to the present invention is applied to this removal of the resist film.

More specifically, as shown in FIG. 1, the semiconductor wafer W on which the unnecessary resist film is left after the ion implantation is held in the chamber 11 of the resist removal apparatus 10a. In this state, water vapor is supplied onto the surface of the resist film on the semiconductor wafer W through the pipe 21 from the water vapor generating unit 20. Together with the supply of the water vapor, ozone generated by the silent discharge in the ozone generating unit 30 is supplied onto the surface of the resist film.

When supplying the ozone, as shown in FIG. 1, the ozone is permeated through the molecule permeable film 33a while controlling the pressure, the flow rate, and the like of the supplied ozone by the control valve 32 so as to cause the difference in pressure between the back and front of the molecule permeable film 33a constituting the filter 33, that is, so as to make the pressure P₀ on the inflow side of ozone higher than the pressure P₁ on the outflow side of ozone.

The ozone generated in the ozone generating unit 30 contains a minute amount of metal derived from an electrode, which is peeled from an electrode surface at the time of the silent discharge, that is, the ozone is contaminated with metal. For example, such metal includes Al from an Al electrode and Cr coated on the electrode surface in order to improve the discharge efficiency. By using the resist removal apparatus 10a according to the present invention with the configuration described above, the metal contamination is removed by the molecule permeable film 33a constituting the filter 33.

When the ozone in which the metal contamination is sufficiently suppressed in the manner as described above is supplied together with water vapor to the resist surface, the ozone is properly adhered to the resist film surface owing to the presence of the water vapor, and the resist is efficiently decomposed by the ozone. Since a minute amount of metal in the ozone is removed in the resist removal process using the ozone decomposition described above, it is possible to prevent the occurrence of the high-concentration metal contamination due to the metal in ozone.

Different from the resist removal apparatus 10a shown in FIG. 1, the conventional resist removal apparatus is not provided with means for removing metal such as the filter 33 composed of the molecule permeable film 33a. Therefore, the ozone generated in the ozone generating unit is supplied to the resist surface without removing the metal therein, and when the resist is decomposed and removed by the ozone supplied together with water vapor, the metal in the ozone is dissolved in the water vapor, and as a result, the high-concentration metal contamination occurs on the semiconductor wafer after the resist process. However, since the metal removal means is provided in the present invention, there is no possibility that the high-concentration metal contamination occurs after the removal of the resist.

In the foregoing description, the resist process in the ion-implantation process has been taken as an example. However, the present invention is not limited to this, and it can be also applied to the resist process in the photolithography process used in the manufacturing process of a semiconductor device such as the MOSIC (Metal Oxide Semiconductor Integrated Circuit).

### Second Embodiment

The case where the configuration according to the present invention is applied to the film forming process in which the metal in process gas such as oxygen is removed and the process gas with no metal contamination, that is, the metal-free process gas is used will be described in the second embodiment.

As described in the first embodiment, it is confirmed that the metal in ozone contaminated with the metal derived from an electrode can be sufficiently removed by using a molecule permeable film as a filter which allows gas to permeate but does not allow foreign matters such as metal contained in the gas to permeate. In the second embodiment, the case where the configuration is applied to the gas other than ozone will be described.

In addition to the resist removal apparatus described in the first embodiment, the film forming apparatus for forming a film with a predetermined thickness on a semiconductor wafer held in a chamber by using the introduced process gas is known as the apparatus in which the gas is introduced into a chamber and a semiconductor wafer is processed by the introduced gas.

In the film forming apparatus, the present invention can be applied to, for example, the atmospheric pressure CVD apparatus, the low pressure CVD apparatus, and the semi-low pressure CVD apparatus. Hereinafter, the case where the semiconductor manufacturing apparatus 10 according to the present invention is used as the CVD apparatus 10b having the film forming function as a gas-processing function will be described.

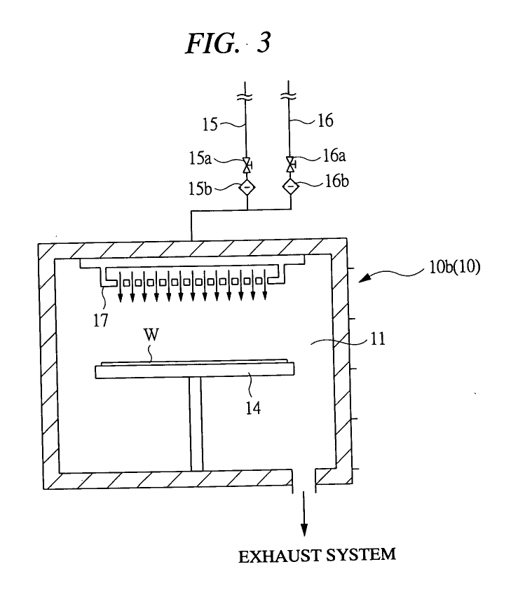

As shown in FIG. 3, in the CVD apparatus 10b, a wafer table 14 is placed in a chamber 11 and a semiconductor wafer W can be held on the wafer table 14. Also, a shower head 17 is provided above the wafer table 14. The shower head 17 introduces process gas such as material gas for forming a thin film from gas supplying means such as gas supply lines 15 and 16 connected to gas generating means such as a gas generating unit and a gas cylinder provided outside the chamber 11, and it sprays the gas to the surface of the semiconductor wafer W like a shower.

The pressure and the flow rate of the gas supplied through the gas supply lines 15 and 16 are controlled by control valves 15a and 16a, and the gas is supplied to the shower head 17 through the filters 15b and 16b. Each of the filters 15b and 16b allows the target gas to permeate but does not allow foreign matters such as a minute amount of metal in the gas to permeate. As the molecule permeable film, a commercially-available poreless molecule permeable film made of fluorocarbon resin is available as described in the first embodiment.

Although not shown in FIG. 3, the chamber 11 is connected to an exhaust system connected to a dry pump and the like, through which the process gas introduced into the chamber 11 is exhausted, the pressure in the chamber 11, or the like is reduced.

By using the CVD apparatus 10b with the configuration described above, the metal contamination derived from the process gas when forming a film by the CVD can be prevented in the manufacturing method of a semiconductor device such as the MOSIC.

For example, when oxygen is supplied through the gas supply line 15 and nitrogen is supplied through the gas supply line 16 as the process gas to form a gate oxide film, a minute amount of metal contained in the oxygen and nitrogen is removed by the filters 15b and 16b. By doing so, it is possible to prevent the metal contamination due to the metal contained in the process gas in the process of forming a film on a semiconductor wafer.

Also, when silane gas is supplied through the gas supply line 15 and ammonium gas is supplied through the gas supply line 16 to form a silicon nitride film as a capacitor insulating film, an extremely small amount of metal contained in the silane gas and ammonium gas is removed by the filters 15b and 16b. By doing so, it is possible to effectively prevent the metal contamination of a semiconductor wafer in the film forming process.

Further, when ozone is supplied through the gas supply line 15 and TEOS (tetraethyl orthosilicate) gas is supplied through the gas supply line 16 to form a silicon oxide film as an interlayer insulating film, a minute amount of metal contained in the ozone and TEOS gas is removed by the filters 15b and 16b. By doing so, it is possible to prevent the metal contamination due to the metal contained in the process gas in the film forming process on a semiconductor wafer.

When forming a film using ozone and TEOS gas, the ozone generated by the method other than the silent discharge has been used so far. However, since the metal derived from an electrode generated by the silent discharge can be effectively removed from the ozone by using the filter 15b composed of a molecule permeable film, the ozone generated by the silent discharge can be sufficiently used for the film forming process by the CVD.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, in the foregoing description of the embodiments, the case of the resist removal apparatus and the film forming apparatus has been taken as an example. However, as long as the semiconductor manufacturing apparatus is provided with metal removal means for removing the metal in the supplied gas by a molecule permeable film, it is within the category of the semiconductor manufacturing apparatus according to the present invention.

Also, in the foregoing illustrative description of the resist removal apparatus and the film forming apparatus, the attention has been paid on the resist removing function and the film forming function. However, of course, the configuration of the apparatus provided with the function other than the resist removing function and the film forming function is also available.

In the foregoing embodiments, the case where the present invention is applied to the manufacture of a semiconductor device is taken as an example. However, the present invention can be applied not only to the field of the manufacture of a semiconductor device but also to other field as long as it relates to the configuration in which metal contained in gas is removed by using a molecule permeable film.

The present invention can be effectively used in the field of removing the contamination metal from gas, for example, in the removal of metal contamination derived from an electrode in the ozone generated by the silent discharge used in the field of the manufacture of a semiconductor device.

1. A manufacturing method of a semiconductor device, the method comprising:
a metal removing step for removing metal by making gas used for processing a semiconductor wafer permeate a molecule permeable film which allows said gas to permeate but does not allow metal contained in said gas to permeate by a pressure difference; and
a gas-processing step for processing said semiconductor wafer by using said gas in which said metal has been removed.

2. The manufacturing method of a semiconductor device according to claim 1,
wherein said gas-processing step is a resist removal processing step to remove a resist provided on said semiconductor wafer by using water vapor and ozone as said gas.

3. The manufacturing method of a semiconductor device according to claim 1,
wherein said gas-processing step is a film forming processing step to form a film on said semiconductor wafer by using said gas as material gas.
